(19) United States
(12) Patent Application Publication
(10) Pub. No.: US 2018/0326484 A1
(43) Pub. Date: Nov. 15, 2018

(54) SYSTEMS AND METHODS FOR FABRICATING AND ASSEMBLING SECTIONAL BINDER JET PRINTED PARTS

(71) Applicant: General Electric Company, Schenectady, NY (US)

(72) Inventors: Carlos Humberto Bonilla Gonzalez, Schenectady, NY (US); Arunkumar Natarajan, Niskayuna, NY (US); Prabhjot Singh, Rexford, NY (US)

(21) Appl. No.: 15/591,941

(22) Filed: May 10, 2017

(51) Int. Cl. B22F 3/10; B33Y 10/00; B33Y 80/00; B33Y 70/00; B33Y 50/02

(52) U.S. Cl. CPC B22F 3/1021; B33Y 10/00; B22F 2998/10; B33Y 70/00; B33Y 50/02; B33Y 80/00

(57) ABSTRACT

A green body multi-sectional binder jet printed part includes a plurality of binder jet printed strategic sections. Each of the plurality of strategic sections comprises a powdered material adhered together with at least one binder and define a portion of an internal feature of the green body multi-sectional part. The plurality of binder jet printed strategic sections are adhered together by a modified binder disposed at interfaces between the plurality of binder jet printed strategic sections of the green body multi-sectional part.

### BACKGROUND

The subject matter disclosed herein relates to additive manufacturing, and more particularly, to binder jetting additive manufacturing techniques.

Additive manufacturing, also known as 3D printing, generally involves printing an article one layer at a time using specialized systems. In particular, a layer of a material may be deposited on a working surface and bonded with another layer of the same or a different material. Additive manufacturing may be used to manufacture parts or articles (e.g., fuel nozzles, fuel injectors, turbine blades, etc.) from computer aided design (CAD) models. Binder jetting is a type of additive manufacturing capable of printing a metal, ceramic, or polymer part by selectively jetting a CAD-determined pattern of binder solution (e.g., liquid glue) into a power bed, overcoating with a fresh layer of powder, and repeating the jetting process until the part is complete. The printed part generally undergoes a curing process, which solidifies the binder solution within the powder to form a green body (e.g., as-printed, unfired) part. The green body part subsequently undergoes a debinding process, which is generally a heat treatment process that decomposes and removes the binder from the green body part, forming a brown (e.g., partially-fired) part. The brown body part then undergoes a sintering process to consolidate the powder particles and form a final (e.g., consolidated) part.

Certain types of parts can include internal features, such as channels. Typically, to define an internal channel in a binder jet printed part, after curing a selectively deposited binder to form a green body part, the green body part generally undergoes depowdering to remove unbound powder from the internal channel of the green body part prior to debinding and sintering. For example, to depowder an internal channel of a green body part, a pressure gradient (e.g., positive pressure or vacuum) may be applied to a first external opening of an internal channel of the green body part, such that a rapid movement of gas (e.g., air) through the internal channel removes unbound powder from a second exterior opening of the internal channel. However, depending on the complexity of internal features of a green body part, depowdering can be challenging. For example, an internal channel of a green body part may be circuitous (e.g., serpentine, tortuous), which can cause loose powder to become lodged in particular portions of the internal channel, resulting in irregularities in the size and shape of internal channel of the consolidated part after sintering. Moreover, since the unbound powder is typically removed from an exterior opening of an internal channel during depowdering, internal features fabricated in this manner have traditionally been limited internal features, such as internal channels, that include at least one exterior opening defined in an external surface of the green body part.

### BRIEF DESCRIPTION

In one embodiment, a green body multi-sectional binder jet printed part includes a plurality of binder jet printed strategic sections. Each of the plurality of strategic sections comprises a powdered material adhered together with at least one binder and define a portion of an internal feature of the green body multi-sectional part. The plurality of binder jet printed strategic sections are adhered together by a modified binder disposed at interfaces between the plurality of binder jet printed strategic sections of the green body multi-sectional part.

In another embodiment, a plurality of green body binder jet printed strategic sections include a first binder jet printed strategic section comprising a first powdered material adhered by a first binder, wherein the first binder jet printed strategic section comprises a first surface defining a first portion of an internal feature of a multi-sectional part. The plurality of green body binder jet printed strategic sections also include a second binder jet printed strategic section comprising a second powdered material adhered by a second binder, wherein the second binder jet printed strategic section comprises a second surface defining a second portion of the internal feature of the multi-sectional part, wherein the plurality of binder jet printed strategic sections are configured to be adhered together using a modified binder selectively disposed between the first and second surfaces of the first and second binder jet printed strategic section.

In another embodiment, a method of manufacturing includes fabricating green body strategic sections via binder jet printing using one or more powdered materials and at least one binder solution, wherein each of the strategic sections comprises a portion of an internal feature of a multi-sectional part. The method includes depowdering the green body strategic sections to yield depowdered strategic sections and assembling the depowdered strategic sections to yield a green body multi-sectional part. The method also includes debinding the green body multi-sectional part to yield a brown body multi-sectional part and sintering the brown body multi-sectional part to yield a consolidated multi-sectional part.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an embodiment of a sectional binder jet printing and assembly system used to fabricate and assemble a plurality of strategic sections of a multi-sectional part, in accordance with embodiments of the present disclosure;

FIG. 2 is a perspective view of an example of a consolidated multi-sectional part, in accordance with embodiments of the present disclosure;

FIG. 3 is a perspective view illustrating assembly of a plurality of strategic sections to form a green body multi-sectional part corresponding to the consolidated multi-sectional part of FIG. 2, in accordance with embodiments of the present disclosure;

FIG. 4 is a perspective view of another example of a consolidated multi-sectional part, in accordance with embodiments of the present disclosure;

FIG. 5 is a perspective view illustrating assembly of a plurality of strategic sections to form a green body multi-sectional part corresponding to the consolidated multi-sectional part of FIG. 4, in accordance with embodiments of the present disclosure;

FIG. 6 is a schematic illustrating assembly of two strategic sections of a multi-sectional part having alignment features, in accordance with embodiments of the present disclosure;

FIG. 7 is a schematic illustrating assembly of three strategic sections of a multi-sectional part having alignment features, in accordance with embodiments of the present disclosure; and

FIG. 8 is a flow chart illustrating a sectional binder jet printing and assembly process for manufacturing a consolidated multi-sectional part, in accordance with embodiments of the present disclosure.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

As used herein, a “working surface” is intended to denote a surface onto which a powder bed layer is deposited during binder jetting processes. As such, the working surface may include a working platform of a sectional binder jet printing and assembly system, a layer of powder, or a previously formed binder jet printed layer. As used herein, the term “internal feature” refers to a cavity, void, hollow, passage, or channel that is defined in an interior volume of a part and that may or may not be in fluid communication with the exterior of the consolidated part. For clarification, as used herein, the terms “channel” and “passage” are used to refer to an internal feature that is in fluid communication with at least one exterior surface of the consolidated part via at least one external opening, while the terms “void” and “hollow” are used herein to refer to an internal feature that is not in fluid communication with at least one external surface of the consolidated part via at least one exterior opening.

As set forth above, a binder jetting process uses a binder solution to bond particles of material into layers that form a printed part. The printed layers may be cured (e.g., via heat, light, moisture, solvent evaporation, etc.) after printing to bond the particles of each layer together to form a green body part. The green body part undergoes a debinding process (e.g., a heat treating process or pre-sintering process) to remove the binder and build up handling strength to form a substantially binder-free brown body part. The brown body part then undergoes a sintering process to form a consolidated part. However, since a brown body part can be substantially more delicate (e.g., have a lower handling strength) than its corresponding green body part, the green body part is generally depowdered before debinding. However, as discussed above, the depowdering process may be challenging. For example, the green body part may include complex and/or small internal features that are difficult to suitably access to perform thorough depowdering. Additionally, the green body part may be susceptible to damage during the depowdering process. As such, depowdering may be tedious and/or laborious, adding time and cost to the manufacturing process while decreasing yields.

With this in mind, present embodiments are directed to a sectional binder jet printing and assembly process that enables effective and efficient depowdering of parts having complex and/or small internal features. As discussed in greater detail below, a multi-sectional binder jet printed part is fabricated from a plurality of binder jet printed strategic sections that are depowdered before being assembled. These green body strategic sections provide multiple access points (e.g., points or surfaces exposing internal features of the part) to facilitate efficient depowdering of the part. After the depowdering process is complete, these strategic sections are assembled using a modified binder (e.g., glue) that temporality joins the strategic sections until the part is debinded and sintered to yield a consolidated part. As such, present embodiments enable more efficient and/or thorough depowdering of binder jetting parts.

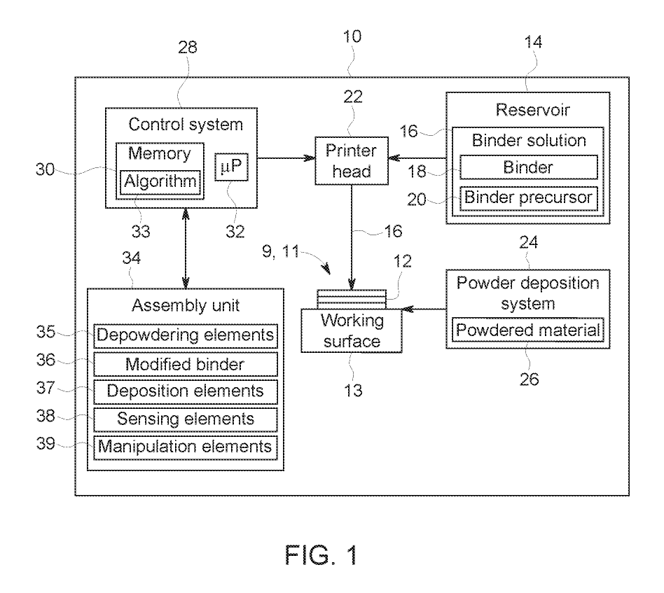

Turning to the drawings, FIG. 1 is a block diagram of a sectional binder jet printing and assembly system 10 capable of fabricating each strategic section 9 of an multi-sectional binder jet printed part 11, in accordance with embodiments of the present approach. In the illustrated embodiment, the system 10 includes a working surface 13 (e.g., a stage or platform 13), a reservoir 14 that stores a binder solution 16 having a binder 18 and/or binder precursor 20, a printer head 22 that is fluidly coupled to the reservoir 14, and a powder deposition system 24 that deposits layers 12 of powdered material 26 (e.g., metal, ceramic, and/or polymer particles) onto the working surface 13. The printer head 22 selectively deposits the binder solution 16 into each layer 12 of powdered material 26, incorporating the binder 18 into each deposited layer 12 of powder in a pattern that is representative of the layer of the strategic section 9 being printed.

The disclosed binder solution 16 may include any binder solution(s) suitable for use in binder jet printing (e.g., suitable for deposition via the printer head 22). In some embodiments, different binder solutions 16 may be applied to print different strategic sections 9. For example, a first binder solution 16 is applied to adhere a first and a second strategic sections 9 together, and a second binder solution 16, materially different from the first binder solution 16 is applied to adhere the second and a third strategic sections 9 together. In some embodiments, the binder solution 16 may have a viscosity between about 5 centipoise (cP) and about 10 cP (e.g., between about 0.05 pascal second (Pa·s) and about 0.01 Pa·s). The powdered material 26 may include any powdered material 26 suitable for binder jet printing. For example, the powdered material 26 may include powdered metal, ceramic, polymer, alloy, composite, or a combination thereof. In some embodiments, the powdered material 26 may include, but is not limited to, stainless steel, such as stainless steel alloys 316 and 304 and hardened stainless steel 15-5 PH. In some embodiments, the powdered material 26 may include, but is not limited to, nickel based alloys, such as Inconel 625, Inconel 718, and MAR-M 242. In certain embodiments, the powdered material 26 may include, but is not limited to, cobalt-chromium based alloys (CoCr) or titanium-based alloys.

The illustrated sectional binder jet printing and assembly system 10 includes a control system 28 for controlling operation of the system. The control system 28 may include a distributed control system (DCS) or any computer-based workstation that is fully or partially automated. For example, the control system 28 can be any device employing a general purpose computer or an application-specific device, which may generally include a suitable memory device 30 and a processing device 32. The memory device 30 may include one or more tangible, non-transitory, machine-readable media collectively storing instructions executable by the processing device 32 to enable the functionality described herein. For example, the memory device 30 may store one or more instructions for controlling operation of the system 10 and may store CAD designs representative of a structure of the part 11 being printed, in certain embodiments.

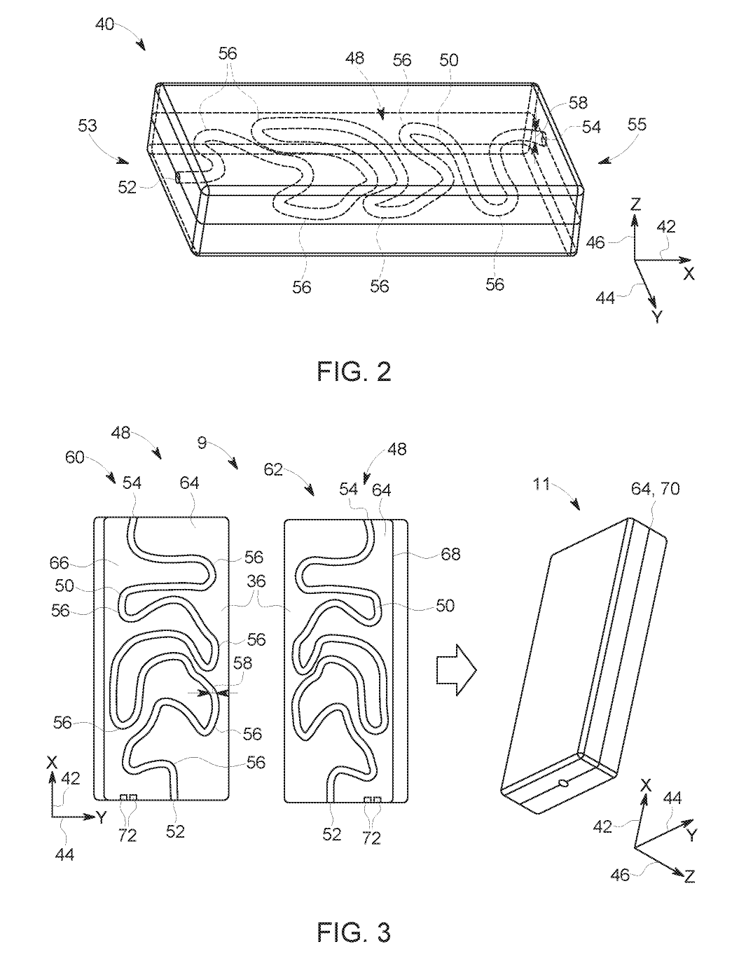

Furthermore, the memory device 30 may store an algorithm or module 33 (e.g., a sectioning algorithm, a set of instructions executable by the processing device 32) that may determine one or more strategic sectioning planes or surfaces, and thus a plurality of strategic sections 9, based on the complete structure of a part 11 being fabricated. For example, in certain embodiments, the algorithm 33 may analyze CAD designs representative of the structure of a part 11 to be printed and determine the strategic sections 9 based on one or more criteria. For example, the criteria may include maximizing access to the internal features of the part 11, generating strategic sections to each include at least one access point into an internal feature, minimizing the number of strategic sections, or a combination thereof. By specific example, in certain embodiments, the processor 32 executing the algorithm 33 receives a CAD design of a part 11 to be fabricated and generates and/or outputs instructions that cause the sectional binder jet printing and assembly system 10 to print the individual strategic sections 9 of the part 11. In some embodiments, the algorithm 33 may be stored external to the control system 28, such as in a controller or computer communicatively coupled to the control system 28. In some embodiments, a user or an operator may directly input or load computer-aided design (CAD) files for the strategic sections 9 of the part 11 into the memory device 30 (e.g., without using the algorithm 33). Examples of the strategic sections 9 are discussed in more detail in FIGS. 2-7.

Additionally, as illustrated in FIG. 1, in certain embodiments, the system 10 also includes an assembly unit 34 that is controlled via control signals received from the control system 28. In certain embodiments, the assembly unit 34 removes each of the strategic sections 9 from the working surface 13 after binder jet printing is complete, depowders and modifies each of the strategic sections 9 using depowdering elements 35, as needed, selectively applies a modified binder 36 (e.g., an adhesive) to at least one surface of each strategic section 9 using deposition elements 37, and assembles the strategic sections 9 together to form the green body multi-sectional binder jet printed part 11. In some embodiments, different modified binders 36 may be applied to adhere different strategic sections 9 together. For example, a first modified binder 36 is applied to adhere a first and a second strategic sections 9 together, and a second modified binder 36, materially different from the first modified binder 36 is applied to adhere the second and a third strategic sections 9 together. In some embodiments, the modified binder 36 may be present in a solution having a viscosity that is greater than that of the binder solution 16 (e.g., greater than about 10 cP or about 0.01 Pa·s). In some embodiments, the modified binder 36 may include viscous thermoplastic and/or thermosets polymer having about 5 vol. % to about 60 vol. % of organic solvent and/or water by volume. In some embodiments, the modified binder 36 may include about 1 vol. % to about 20 vol. % of the powdered material 26. The inclusion of the powdered material 26 (e.g., metal powders) in the modified binder 36 may make the modified binder 36 more viscous as compared to the binder solution 16 set forth above. Furthermore, the inclusion of the powdered material 26 may provide a gradient material for a smoother transition when different strategic sections 9 of a part 40 are printed using different powdered materials (e.g., Inconel 625 and Inconel 718).

As such, the assembly unit 34 may include suitable sensing elements 38 (e.g., proximity sensors, displacement sensors, cameras, etc.) and suitable manipulation elements 39 (e.g., robotic arms, rotating stages, conveyor belts, etc.) to enable the assembly unit 34 to inspect and manipulate each of the strategic sections 9 in three-dimensional space (e.g., about 6-axes of rotation). The depowdering elements 35 may include, for example, vacuum nozzles, blowing nozzles, and/or tooling components (e.g., grinding, scraping, gauging, or cutting mechanisms) suitable for removing unbound powdered material 26 and irregularities from the strategic sections 9 before assembly, as discussed in greater detail below. The deposition elements 37 may include, for example, rollers, brushes, jet or spray devices capable of selectively depositing the modified binder 36 onto surfaces of the strategic sections 9, as discussed in greater detail below. After selective deposition of the modified binder 36, based on control signals from the control system 28, the assembly unit 34 adheres together the strategic sections 9 using the sensing elements 38 and manipulation elements 39. In certain embodiments, the system 10 may not include an assembly unit 34, and the strategic sections 9 may be depowdered and/or assembled manually. As discussed below, the present technique enables internal features (e.g., internal channels and/or voids) of the multi-sectional part 11 to be defined at particular surfaces of (e.g., particular interfaces between) the strategic sections 9, which can enable thorough depowering and/or tooling of these internal features prior to assembly. As such, the present technique enables the manufacture of consolidated binder jet printed parts having internal features that are difficult or impossible to manufacture using traditional binder jet printing techniques. In addition, the present technique may also enable the manufacture of binder jet printed parts that may be difficult or impossible to manufacture via a single printing process. For example, a large part (e.g., too large to fit in the system 10) may be printed in strategic sections 9 and assembled to form a multi-sectional part 11 part that is otherwise difficult or impossible to be fabricated via a single printer process. The multi-sectional part 11 may or may not include internal features.

FIG. 2 is a perspective view of a consolidated multi-sectional part 40 (e.g., a consolidated multi-sectional binder jet printed part 40) that can be manufactured using the techniques and systems disclosed herein. In the illustrated embodiment, the multi-sectional part 40 is oriented with respect to an x-direction 42, a y-direction 44, and a z-direction 46. The multi-sectional part 40 has an internal feature 48 in the form of an internal passage or channel 50 extending through the part 40, between a first exterior opening 52 and a second exterior opening 54. The illustrated openings 52 and 54 fluidly couple the internal channel 50 to external surfaces 53 and 55 of the part 40, respectively. As illustrated, in certain embodiments, the internal passage 50 is convoluted (e.g., tortuous, serpentine), having numerous curvatures 56. In some embodiments, the internal passage 50 may be substantially straight (e.g., with substantially no curve). However, as illustrated, in some embodiments, the internal passage 50 can include relatively sharp or tight curvatures 56, which can render the internal passage 50 especially difficult to depowder from the exterior openings 52 and 54 using traditional methods, as described above.

The illustrated internal passage 50 may be described as having a characteristic width 58 (e.g., diameter). For example, the characteristic width 58 of an internal passage 50 may be constant or may vary (e.g., increase or decrease) along the length of the internal passage 50, in certain embodiments. In some embodiments, the characteristic width 58 may be any suitable value, including characteristic widths 58 as small as about 0.015 inches (e.g., about 0.04 centimeters). In some embodiments, the characteristic width 58 of an internal passage 50 may be between about 0.015 inches (e.g., about 0.04 centimeters) and about 0.05 inches (e.g., about 0.13 centimeters). In certain embodiments, the characteristic width 58 may be between about 0.05 inches (e.g., about 0.13 centimeters) and about 0.1 inches (e.g., about 0.25 centimeters). As may be appreciated, at least in part due to the complex geometry and/or small dimensions or feature size (e.g., the small characteristic width 58) of an internal feature 48 (e.g., the internal passage 50), the depowdering process may be challenging to remove the loose powdered material 26 (e.g., powdered material 26 not bonded by the binder solution 16) to clear the internal feature 48 before debinding and sintering, as discussed above.

FIG. 3 illustrates assembly of two binder jet printed strategic sections 9 to form a multi-sectional part 11, in accordance with embodiments of the present approach. It may be noted that, after debinding and sintering, the illustrated multi-sectional part 11 forms the consolidated multi-sectional part 40 of FIG. 2. In the illustrated embodiment, a first section 60 and a second section 62 of the multi-sectional part 11 meet along a sectional plane 64. In certain embodiments, a multi-sectional parts 11 may include additional (e.g., 2, 3, 4, 5, 6, or more) strategic sections 9 and sectional planes 64, such that internal features 48 of the multi-sectional part 11 are divided (e.g., by the sectional planes) into the multiple (e.g., 2, 3, 4, 5, 6, or more) strategic sections 9. For example, the sectional plane 64 of the part 11 illustrated in FIG. 3 bisects the internal features 48 into two substantially equal portions. More specifically, the sectional plane 64 bisects both the part 11 and the internal passage 50 along the x-direction 42. As such, the first section 60 of the illustrated multi-sectional part 11 provides a first exposed surface 66, and the second section 62 of the illustrated multi-sectional part 11 provides a second exposed surface 68. It may be appreciated that the exposed surfaces 66 and 68 maximize access to (e.g., maximize surface exposure of) the internal features 48 of the part 11 for more efficient and/or thorough depowdering. For example, in the illustrated embodiment, fabricating the part 11 sections 60 and 62 enables a depowdering process (e.g., vacuuming, blowing, tooling) to be performed on substantially all of the surfaces of the internal passage 50 (e.g., along the length). As set forth above, the dimensions of the strategic sections 60 and 62 (e.g., the position of the sectional plane 64) may be determined by the algorithm 33, or determined by a user or an operator, and stored in the memory device 30 of the control system 28. Specifically, each of the strategic sections 9 (e.g., the first and second sections 60 and 62) are stored as a CAD design that is individually printed via the sectional binder jet printing and assembly system 10.

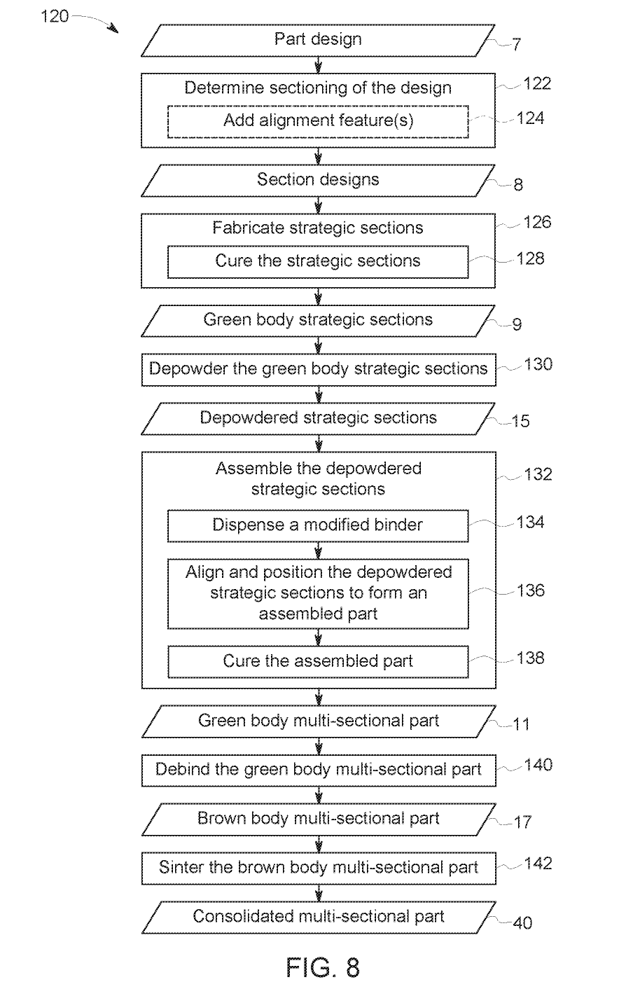

As will be discussed in greater detail in FIG. 8, present embodiments enable a thorough depowdering process to be performed on each of the plurality of strategic sections 9 (e.g., the first and second sections 60 and 62) of the multi-sectional printed part 11 (e.g., the green body multi-sectional binder jet printed part 11). After binder jet printing the sections 60 and 62, the modified binder 36 (e.g., a glue, epoxy, or resin) is applied along the sectional plane 64 (e.g., rolled, painted, or deposited onto the first surface 66, the second surface 68, or both) before bringing the surfaces 66 and 68 into contact with one another to assemble the multi-sectional part 11. For example, the assembled part 11 is formed by attaching or gluing the first surface 66 to the second surface 68 using the modified binder 36, with appropriate alignment of the sections 60 and 62. It may be noted that the modified binder 36 may be applied to the first surface 66, the second surface 68, or both; however, the modified binder 36 is not applied to the surface of the internal features 48 (e.g., the surface of the internal passage 50). As set forth above, the assembled part 11 subsequently undergoes debinding and sintering processes and/or any other suitable post-printing processes (e.g., machining, surface treatment, etc.) to eventually form the consolidated multi-sectional binder jet printed part 40 illustrated in FIG. 2.

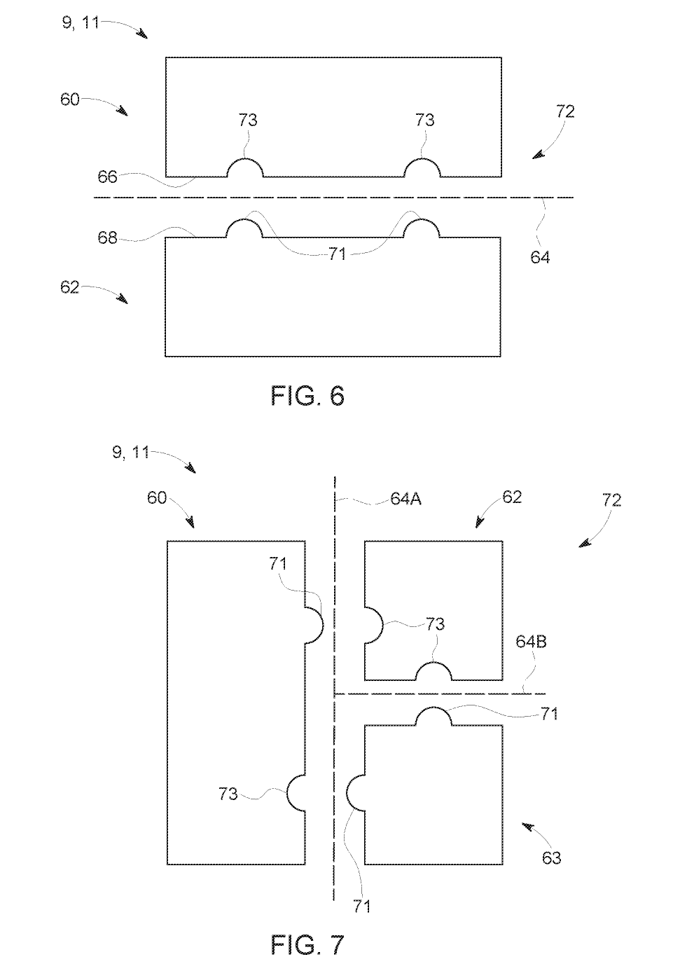

In some embodiments, the strategic sections 9 of a multi-sectional part 11 may include one or more alignment features 72, such as one or more protrusions and corresponding recesses (e.g., corresponding male and female mating features), disposed on the surfaces 66 and 68 of the strategic sections 60 and 62, respectively, to guide alignment and assembly of the part 11. Examples of the one or more alignment features 72 are discussed in greater detail below with respect to FIGS. 6-7. Furthermore it should be noted that, although the sectional plane 64 of the illustrated embodiment approximately coincides with a particular x-y plane (e.g., a plane along the x-direction 42 and y-direction 44), in some embodiments, the sectional plane 64 may be oriented along the x-direction 42, the y-direction 44, the z-direction 46, or any combinations thereof. In some embodiments, the sectional plane 64 may bisect the part 11 along any direction(s), or may bisect an internal feature 48 (e.g., internal channel 50) of the part 11. In some embodiments, the part 11 may be sectioned into more than two strategic sections along more than one sectional planes. In some embodiments, a plurality of sectional planes may dissect the part 11 in any suitable manner (e.g., along any suitable direction(s)) to expose the internal features 48 for a thorough depowdering process.

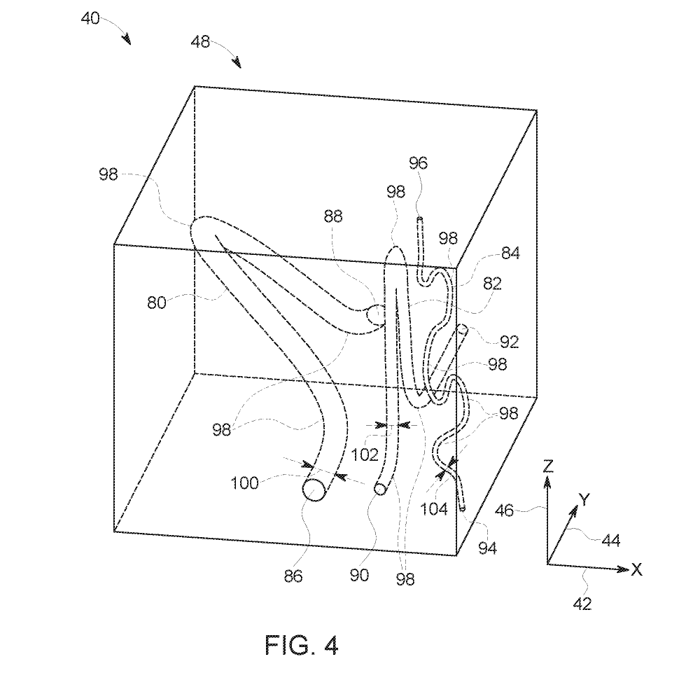

FIG. 4 is a perspective view of another example embodiment of a consolidated multi-sectional part 40 (e.g., consolidated multi-sectional binder jet printed part 40) manufactured using techniques and/or systems of the present disclosure. In the illustrated embodiment, the multi-sectional part 40 is oriented with respect to the x-direction 42, the y-direction 44, and the z-direction 46. The illustrated multi-sectional part 40 has internal features 48 that include: a first internal passage 80, a second internal passage 82, and a third internal passage 84. The first internal passage 80 extends through the multi-sectional part 40 between exterior openings 86 and 88, the second internal passage 82 extends through the part 40 between exterior openings 90 and 92, and the third internal passage 84 extends through the part 40 between exterior openings 94 and 96. As illustrated, the openings (e.g., the openings 86, 88, 90, 92, 94, and 96) are disposed on external surfaces and are fluidly coupled to the respective internal passages (e.g., internal passages 82, 84, 86) of the multi-sectional part 40. Each of the illustrated internal passages 80, 82, and 84 have curvatures 98. In certain embodiments, some or all of the one or more curvatures 98 may have sharp curves. In other embodiments, some or all of the first, second, and third internal passages 80, 82, and 84 may be substantially straight (e.g., with no substantial curves).

The first, second, and third internal passages 80, 82, and 84 may have characteristic widths or diameters 100, 102, and 104, respectively. The characteristic widths 100, 102, and 104 may each be a constant value or may vary (e.g., increase or decrease) along the respective length of the internal passages 80, 82, and 84. The characteristic widths 100, 102, and 104 may independently be any suitable values, including as small as about 0.015 inches (e.g., 0.04 centimeters), in certain embodiments. In certain embodiments, the characteristic widths 100, 102, and 104 may be between about 0.015 inches (e.g., about 0.04 centimeters) and about 0.05 inches (e.g., about 0.13 centimeters). In some embodiments, the characteristic widths 100, 102, and 104 may be between about 0.05 inches (e.g., about 0.13 centimeters) and about 0.1 inches (e.g., about 0.25 centimeters). As may be appreciated, due to the complex geometry and/or small dimensions or feature size of the internal features 48 (e.g., the first, second, and third internal passages 80, 82, and 84), if the multi-sectional part 11 were binder jet printed as a single, integral part, it would be difficult or impossible to clear the internal features 48 (e.g., the first, second, and third internal passages 80, 82, and 84) of loose powdered material 26 by applying a pressure gradient (e.g., vacuum or pressure) to the exterior openings 86, 88, 90, 92, 94, and 96 of the internal passages 80, 82, and 84.

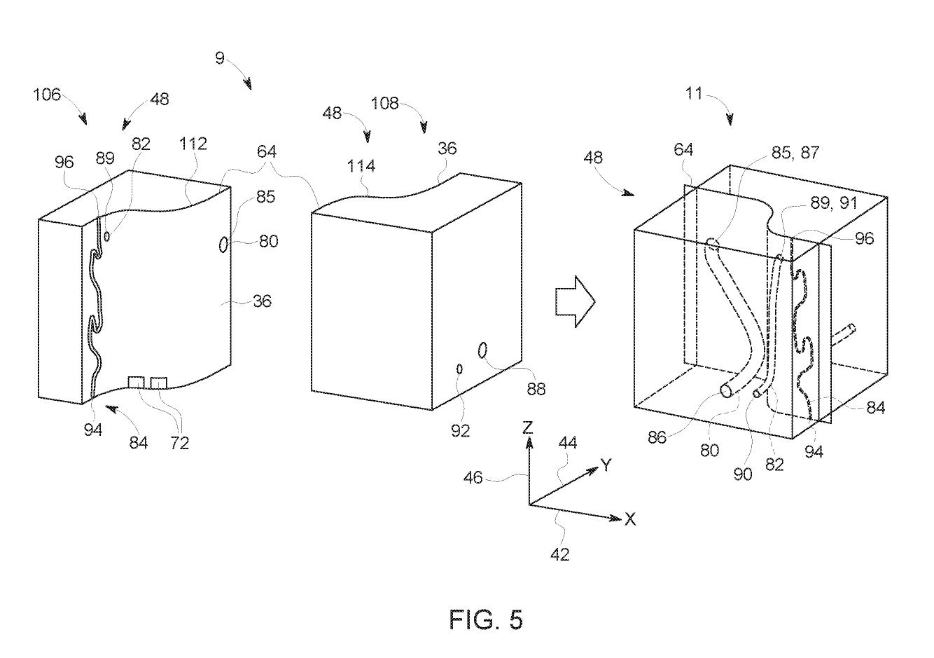

FIG. 5 illustrates assembly of strategic sections 9 (e.g., a plurality of binder jet printed strategic sections 9) to form a multi-sectional part 11 (e.g., a green body multi-sectional binder jet printed part 11), in accordance with an embodiment of the present approach. It may be noted that the illustrated multi-sectional part 11 forms the consolidated multi-sectional binder jet printed part 40 of FIG. 4 after debinding and sintering. In the illustrated embodiment, a first section 106 and a second section 108 of the multi-sectional part 11 meet along a sectional plane 64. In certain embodiments, a multi-sectional parts 11 may include additional (e.g., 2, 3, 4, 5, 6, or more) strategic sections 9 and sectional planes 64, such that internal features 48 of the multi-sectional part 11 are divided (e.g., by the sectional planes) into the multiple (e.g., 2, 3, 4, 5, 6, or more) strategic sections 9. For example, the sectional plane 64 of the part 11 illustrated in FIG. 5 divides the internal features 48 into two portions (e.g. the first and second sections 106 and 108) and creates exposed surfaces 112 and 114. It may be appreciated that the exposed surfaces 112 and 114 maximize access to (e.g., maximize the number of access points and/or surface exposure of) the internal features 48 of the part 11 for more efficient and/or thorough depowdering. For example, in the illustrated embodiment, fabricating the part 11 in sections 106 and 108 enables a depowdering process (e.g., vacuuming, blowing, tooling) to be performed on substantially all of the surfaces of the internal passage 84 (e.g., along the length), on the openings 86 and 88 and additional openings 85 and 87 (e.g., openings on the exposed surfaces 112 and 114) of the internal passage 80, and on the openings 90 and 92 and additional openings 89 and 91 (e.g., openings on the exposed surfaces 112 and 114) of the internal passage 82. As set forth above, the dimensions of the strategic sections 106 and 108 (e.g., the position of the sectional plane 64) may be determined by the algorithm 33 or determined by a user or an operator and stored in the memory device 30 of the control system 28. Specifically, each of the strategic sections 9 (e.g., the first and second sections 106 and 108) are stored as a CAD design that is individually printed via the sectional binder jet printing and assembly system 10.

As may be appreciated, the depowdering process is performed on each of the strategic sections 9 (e.g., the first and second sections 106 and 108). Subsequently, the modified binder 36 (e.g., a glue) is applied along the sectional plane 64 (e.g., to the first surface 106, to the second surface 108, or both) and the strategic sections 9 are suitably positioned in contact with one another to form the assembled multi-sectional part 11 (e.g., the assembled green body multi-sectional binder jet printed part 11). For example, the assembled multi-sectional part 11 is formed by attaching or gluing (e.g., via the modified binder 36) the first strategic section 106 to the second strategic section 108 with appropriate alignment. The modified binder 36 may substantially cover the exposed surface 112, the exposed surface 114, or both. The modified binder 36 is not applied to the surfaces of the internal features 48 (e.g., the first, second, and third internal passages 80, 82, and 84). The multi-sectional part 11 subsequently undergoes debinding and sintering, and/or any other suitable post-printing processes (e.g., machining, surface treatment, etc.), to form the consolidated part 40, as shown in FIG. 4.

As mentioned above, in certain embodiments, the strategic sections 9 of a green body part 11 may include one or more alignment features 72. In certain embodiments, these alignment features 72 can include mating features (e.g., male protrusions and corresponding female recesses) disposed on the surfaces (e.g., surfaces 66 and 68 of FIG. 3, surfaces 112 and 114 of FIG. 5) of strategic sections 9 (e.g., sections 60 and 62 of FIG. 3, sections 106 and 108 of FIG. 5), to guide alignment and assembling of the plurality of strategic sections. FIGS. 6 and 7 illustrate examples of multi-sectional parts 11 having strategic sections 9 that include alignment features 72, in accordance with embodiment of the present approach.

In FIG. 6, the illustrated embodiment of a multi-sectional part 11 (e.g., a green body multi-sectional binder jet printed part 11) includes two strategic sections 9, a first strategic section 60 having a first surface 66 and a second strategic section 62 having a second surface 68. The illustrated strategic sections 9 each include a portion of the alignment features 72 to guide alignment and/or assembly of the strategic sections 9 to form the assembled multi-sectional part 11. For example, the illustrated alignment features 72 include protrusions 71 disposed on one of the surfaces 68 and corresponding recesses 73 disposed on the opposite surface 66. As may be appreciated, the protrusions 71 are designed to be received by corresponding recesses 73 when the strategic sections 60 and 62 are assembled to form the assembled multi-sectional part 11.

In the illustrated embodiment in FIG. 7, a multi-sectional part 11 (e.g., a green body multi-sectional binder jet printed part 11) includes three strategic sections, a first section 60, the second section 62, and the third section 63, that meet along two sectional planes 64A and 64B. The illustrated alignment features 72 include protrusions 71 and corresponding respective recesses 73 are disposed on opposite surfaces of the strategic sections 9 (e.g., along the sectional planes 64A and 64B). The protrusions 71 are designed to be received by the corresponding recesses 73 when the strategic sections 9 (e.g., sections 60, 62, and 63) are assembled to form the multi-sectional part 11.

FIG. 8 is a flow chart illustrating a sectional binder jet printing and assembly process 120 for manufacturing a consolidated multi-sectional part 40, in accordance with embodiments of the present disclosure. One or more steps of the process 120 may be executed by the control system 28 of the sectional binder jet printing and assembly system 10 of FIG. 1. To facilitate discussion of aspects of the process 120 illustrated in FIG. 8, reference is made to the structures in FIGS. 2-7, which generally correspond to the inputs and outputs of certain steps of the illustrated process 120. The process 120 begins with the processing device 32 of the system 10 receiving a design 7 (e.g., a CAD design 7 for a consolidated multi-sectional part 40 to be manufactured), and then determining sectioning of the design 7 (block 122) using the algorithm 33 stored in the memory device 30. As set forth above, the algorithm 33 analyzes the design 7 and determines how to divide the design 7 into the strategic sections 9. For example, by executing the algorithm 33, the processing device 32 can determine and output designs 8 (e.g., CAD designs 8) representative of the strategic sections 9 and provide suitable instructions to cause the system 10 to binder jet print the strategic sections 9.

For example, to divide the design 7 into strategic sections 9, in certain embodiments, the processing device 32 executing the algorithm 33 may determine one or more sectional planes 64 that enable or maximize access to internal features 48 in the structure of the part 40. For example, in certain embodiments, at least one sectional plane 64 may intersect (e.g., bisect) each internal feature 48 and provide direct access (e.g., surface access) to substantially all surfaces of the internal features 48 prior to assembly. Additionally, in certain embodiments, the processing device 32 executing the algorithm 33 may consider additional factors as well, such as optimizing the binder jetting efficiency, minimizing the total number of strategic sections, or a combination thereof. In some embodiments, the processing device 32 executing the algorithm 33 may add (block 124) the one or more alignment features 72 to the strategic sections 9 to aid alignment and/or assembling of the strategic sections 9 into the assembled multi-sectional part 11. In some embodiments, instead of utilizing the algorithm 33, a user or an operator may determine sectioning of the part (block 122) and/or provide the designs 8 of the strategic sections 9 (e.g., directly into the control system 28). The designs 8 of the strategic sections 9 may also be stored in the memory 30 of the control system 28 of the system 10.

Once the designs 8 of the strategic sections 9 have been determined, processing device 32 may provide suitable control signals to other portions of the sectional binder jet printing and assembly system 10 to fabricate (block 126) the strategic sections 9 in series or in parallel. For example, during binder jet printing, the powder deposition system 24 deposits the powdered material 26 to form layers 12. The printer head 22 selectively deposits the binder solution 16 into the layers 12 to print the binder solution 16 onto the one or more layers or powders 12 in a pattern that is representative of the layer 12 of the strategic section 9 of the part 11 being printed. The depositions of the binder solution 16 and the powdered material 26 are generally alternated in a repeated manner until printing of each of the strategic sections 9 (e.g., green body strategic sections 9) of the part 40 is completed. In some embodiments, the strategic sections 9 may be printed using the same powdered material 26 (e.g., Inconel 625). In some embodiments, one or more of the strategic sections 9 may be printed using different powdered materials 26. For example, one of the plurality of the strategic sections may be printed using Inconel 625 powdered material 26, and one of the plurality of the strategic sections may be printed using Inconel 718 powdered material 26. In certain embodiments, fabrication of block 126 may include a separate curing step (block 128) following printing of the strategic sections 9 of the part 40. For example, in certain embodiments, the printed strategic sections 9 may be exposed to heat, light, or any other suitable curing method to enhance a strength of the binder 18 in the powdered material 26 in the strategic sections 9.

Subsequently, the process 120 continues with the processing device 32 providing suitable signals to the assembly device 34 to cause the depowdering elements 35 to depowder (block 130) each of the green body strategic sections 9 to remove unbounded powdered material 26. It may be noted that, in other embodiments, the depowdering process may be performed manually. It should be appreciated that, because the strategic sections 9 include portions of internal features 48 of the part 40 disposed exposed surfaces, the depowdering process can be performed more efficiently and/or thoroughly, as discussed in detail above with respect to FIGS. 2-5. After depowdering, the resulting depowdered strategic sections 15 (e.g., depowdered green body strategic sections 15) are ready for assembly.

Following the depowdering process, the process 120 continues with assembling (block 132) the depowdered strategic sections 15. For example, in certain embodiments, the processing device 32 may provide suitable signals to the assembly device 34 to cause the deposition elements 37 to selectively deposit (e.g., paint, roll, spray) the modified binder 36 onto particular surfaces of the depowdered strategic sections 15. The modified binder 36 may be dispensed on one or both of the surfaces formed by the sectional planes 64 (block 134). For example, the modified binder 36 may be selectively dispensed on one or both of the surfaces 66 and 68 of the strategic sections 60 and 62, respectively, as shown in FIG. 3. For example, the modified binder 36 may be selectively dispensed on one or both of the surfaces 112 and 114 of the strategic sections 106 and 108, respectively, as shown in FIG. 5. Further, it should be noted that the modified binder 36 may be dispensed via any suitable method, such as brushing, rolling, dispensing, and spraying in a manner that does not allow the modified binder 36 to be dispensed in or over internal features 48 of the part 40. Once the modified binder 36 is selectively dispensed during the assembly of block 132, the processing device 32 may provide suitable signals to the assembly device 34 to cause the manipulation elements 39 to align and position (block 136) each the strategic sections 9 to assemble together. In certain embodiments, the assembly of block 132 may include a curing process (block 138). For example, in certain embodiments, one or more curing processes set forth above (e.g., in block 126) may be used to cure and increase the strength of the modified binder 36 that adheres together the strategic sections 9 of the multi-sectional part 11. The assembly process of block 132 results in a green body multi-sectional part 11 that is ready for debinding and sintering.

The process 120 illustrated in FIG. 8 continues with debinding (block 140) the green body multi-sectional part 11 to remove the binder 18 and the modified binder 36 from the green body multi-sectional part 11, yielding an assembled brown body part 17 (e.g., multi-sectional part). In certain embodiments, the debinding process (block 140) generally involves heating the green body multi-sectional part 11 above a vaporization, decomposition, or combustion temperature of the binder 18 and the modified binder 36. After debinding, the process 120 continues with sintering (block 142) the brown body assembled part 17. The sintering process generally consolidates particles of the powdered materials 26 and increases the density of the part, thereby forming a substantially solid and consolidated part 40. The sintering process (block 142) generally involves heating the brown body multi-sectional part 11 to a sintering temperature, which is below the melting point of the melting point of the powdered materials 26, to form the consolidated part 40.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A green body multi-sectional binder jet printed part, comprising:
a plurality of binder jet printed strategic sections, wherein each of the plurality of strategic sections comprises a powdered material adhered together with at least one binder and define a portion of an internal feature of the green body multi-sectional part, and wherein the plurality of binder jet printed strategic sections are adhered together by a modified binder disposed at interfaces between the plurality of binder jet printed strategic sections of the green body multi-sectional part.

2. The green body multi-sectional binder jet printed part of claim 1, wherein the modified binder is selectively disposed at interfaces between the plurality of binder jet printed strategic sections of the green body multi-sectional part such that the modified binder does not substantially contact the internal feature.

3. The green body multi-sectional binder jet printed part of claim 1, wherein the internal feature has one or more characteristic widths between about 0.04 centimeters and about 0.13 centimeters.

4. The green body multi-sectional binder jet printed part of claim 1, wherein the internal feature comprises one or more channels, each having one or more curvatures.

5. The green body multi-sectional binder jet printed part of claim 1, wherein the plurality of strategic sections each comprises one or more alignment features that align and couple together within the multi-sectional part.

6. The green body multi-sectional binder jet printed part of claim 1, wherein the powdered material comprises stainless steel comprising stainless steel alloy 316, stainless steel alloy 304, or hardened stainless steel 15-5 PH.

7. The green body multi-sectional binder jet printed part of claim 1, wherein the powdered material comprises nickel based alloys comprising Inconel 625, Inconel 718, or MAR-M 242.

8. The green body multi-sectional binder jet printed part of claim 1, wherein the powdered material comprises cobalt-chromium based alloy or titanium based alloy.

9. The green body multi-sectional binder jet printed part of claim 1, wherein the powdered material comprises two or more materially different metals or alloys.

10. A plurality of green body binder jet printed strategic sections, comprising
a first binder jet printed strategic section comprising a first powdered material adhered by a first binder, wherein the first binder jet printed strategic section comprises a first surface defining a first portion of an internal feature of a multi-sectional part; and
a second binder jet printed strategic section comprising a second powdered material adhered by a second binder, wherein the second binder jet printed strategic section comprises a second surface defining a second portion of the internal feature of the multi-sectional part, wherein the plurality of binder jet printed strategic sections are configured to be adhered together using a modified binder selectively disposed between the first and second surfaces of the first and second binder jet printed strategic section.

11. The plurality of green body binder jet printed strategic sections of claim 10, wherein the first binder and the second binder are the same binder.

12. The plurality of green body binder jet printed strategic sections of claim 10, wherein the internal feature comprises one or more internal channels having one or more characteristic lengths between about 0.04 centimeters and about 0.13 centimeters.

13. The plurality of green body binder jet printed strategic sections of claim 11, wherein an interface between the first and second strategic sections bisects the one or more internal channels along respect lengths of the one or more internal channels, cross respect lengths of the one or more internal channels, or a combination thereof

14. The plurality of green body binder jet printed strategic sections of claim 10, wherein the first and second strategic sections are configured to be cured after being adhered together and subsequently the assembled multi-sectional part is configured to be cured, debinded, and sintered to yield a consolidated multi-sectional part.

15. A method of manufacturing comprising:
fabricating green body strategic sections via binder jet printing using one or more powdered materials and at least one binder solution, wherein each of the strategic sections comprises a portion of an internal feature of a multi-sectional part;
depowdering the green body strategic sections to yield depowdered strategic sections;
assembling the depowdered strategic sections to yield a green body multi-sectional part;
debinding the green body multi-sectional part to yield a brown body multi-sectional part; and
sintering the brown body multi-sectional part to yield a consolidated multi-sectional part.

16. The method of manufacturing of claim 15, wherein the green body strategic sections enable complete access to the internal feature.

17. The method of manufacturing of claim 15, wherein assembling the depowdered strategic sections comprises dispensing a modified binder on one or more interfaces between the depowdered strategic sections, wherein the modified binder is not dispensed onto or into the portion of the internal features of the green body strategic sections.

18. The method of manufacturing of claim 17, comprising aligning and positioning the depowdered strategic sections interfaced with the modified binder to yield an assembled part.

19. The method of manufacturing of claim 17, comprising curing the assembled part.

20. The method of manufacturing of claim 17, wherein the modified binder comprises about 1% to about 20% of the powdered material by volume and is more viscous than the at least one binder solution.

21. The method of manufacturing of claim 17, wherein the modified binder comprises about 5% to about 60% of organic solvent and/or water by volume and is more viscous than the at least one binder solution.
